(19) United States
(12) Patent Application Publication
(10) Pub. No.: US 2009/0015520 A1
(43) Pub. Date: Jan. 15, 2009

(54) PLASMA DISPLAY PANEL APPARATUS AND METHOD FOR DRIVING THE SAME

(76) Inventors: Keiji Akamatsu, Osaka (JP); Kenji Ogawa, Osaka (JP); Mitsuo Ueda, Hyogo (JP)

Correspondence Address: SNELL & WILMER L.L.P. (Panasonic), 600 ANTON BOULEVARD, SUITE 1400, COSTA MESA, CA, 92626, US

(21) Appl. No.: 11/574,365

(22) PCT Filed: Mar. 23, 2006
(86) PCT No.: PCT/JP2006/305802

§ 371 Date: Sep. 29, 2008

(30) Foreign Application Priority Data
Apr. 13, 2005 (JP) 2005-115517

(51) Int. Cl. G09G 3/28

(52) U.S. Cl. 345/67; 345/60; 345/208; 315/169.4

(57) ABSTRACT

The present invention provides a plasma display panel and a method for driving the plasma display panel each of which ensures to suppress problems associated with an erroneous discharge resulting from accidental occurrence of a strong discharge in a reset period as well as with an address discharge delay. The problems are suppressed without applying an auxiliary erase pulse after the reset period ends. As a result, image display is provided with no flickering and good quality. The reset period includes a first step of applying a voltage having an ascending ramp waveform and a second step of applying a voltage having a descending ramp waveform. Between the first and second steps, a potential change waveform having a rise or fall (voltage change pulse) is applied at least to scan electrodes, sustain electrodes, or address electrodes.

### TECHNICAL FIELD

The present invention relates to a plasma display panel apparatus and a method for driving the plasma display panel apparatus. Especially, the present invention relates to a technique of preventing occurrence of an erroneous discharge in a reset period.

### BACKGROUND ART

A plasma display panel (hereinafter, simply “PDP”) is composed of two panels, namely front and back panels, opposing each other via a plurality of barrier ribs. Between adjacent barrier ribs, red (R), green (G), and blue (B) phosphor layers are disposed. A gap between the two glass panels is filled with a discharge gas and serves as a discharge space. The front panel is provided with a plurality of pairs of display electrodes formed on the glass surface. Each pair of display electrode is composed of a scan electrode and a sustain electrode. The back panel is provided with a plurality of data (address) electrodes formed in parallel to one another on the glass surface. In addition, the address electrodes extend in a direction orthogonal, via the discharge space, to the pairs of display electrodes. Appropriate pulses, such as a reset pulse, a scan pulse, an address pulses, a sustain pulse, and an erase pulse, are applied to the respective electrodes according to the sub-field method (in-field time division display method). For example, the pulses are applied through the drive waveform process illustrated in FIG. 4. With application of such pulses, a discharge occurs in the discharge gas, which causes the phosphor layers to emit light. A PDP apparatus having such a PDP is advantageous in that the depth dimension and weight of the PDP apparatus do not increase much with the screen-size, as compared with a conventional CRT display. In addition, the PDP apparatus is also advantageous in that the viewing angle is not limited.

FIG. 4 is a view illustrating the example of drive waveforms applied to the respective electrodes of a typical PDP. Generally, a PDP apparatus displays about 50 to 100 images per second on a continual basis during operation. Each image is called a field. According to a general PDP driving method, each field is divided into a plurality of sub-fields (SFs) and by controlling ON/OFF of the sub-fields, a desired grayscale level is displayed. For example, the patent document 1 listed below discloses a sub-field method for minimizing light emission that does not contribute to grayscale display. As a result, the black luminance level is suppressed and thus the contrast is enhanced. The following briefly describes the driving method.

Each sub-field includes a reset period, an address period, and a sustain period. In each reset period, either of an all-cell reset operation and a selective reset operation is performed. Through the all-cell reset operation, a reset discharge is caused in all the discharge cells usable to display images, so that all the discharge cells are reset. Through the selective reset operation, a reset discharge is caused selectively in discharge cells in which a sustain discharge occurred in the immediately previous sub-field. In the example illustrated in FIG. 4, one field is composed of x sub-fields.

FIG. 5 is an enlarged view of FIG. 4 to show the part of the sub-fields corresponding to the all-cell reset period.

In the first step of the reset period, a ramp voltage having a gently ascending ramp waveform is applied to the scan electrodes SCN1-SCNn. Under normal conditions, application of the ramp voltage causes a weak discharge (normal reset emission, which is not noticeable to human eye) between each of the scan electrodes SCN1-SCNn and a corresponding one of the sustain electrodes SUS1-SUSn and of the address electrodes D1-Dm (line “a” in FIG. 5). At this time, each scan electrode acts as an anode, whereas each sustain electrode as well as each address electrode act as a cathode.

In recent years, some studies suggest that the luminous efficiency of a PDP improves by increasing the partial pressure of Xenon (Xe) contained in a discharge gas sealed within the PDP. Unfortunately, however, the increase in Xe partial pressure involves a longer discharge delay. This discharge delay is problematic especially when there is an insufficient amount of priming (an initiator of discharge=excited particles). In such a case, a strong discharge rather than a weak discharge occurs accidentally in some discharge cells (abnormal reset emission) (lines “b” to “d” in FIG. 5). If a strong discharge occurs in the second step of the reset period during which a gently descending ramp waveform is applied (line “d” in FIG. 5), the strong discharge produces an effect substantially identical to an address discharge before an address discharge actually takes place. As a result, it is no longer possible to properly control a sustain discharge, which leads to image deterioration.

The above-noted problems associated with a strong discharge arises even if the sustain electrodes SUS1-SUSn, each of which serves as a cathode in the second step of the reset period, are covered with a protective layer 7 having a high secondary electron emission coefficient. In addition, such an abnormal reset emission may be caused due to the factors other than the partial pressure of Xenon. For example, such an abnormal reset emission may be caused depending on the electron emission coefficient of the phosphor layers or the state of wall voltage accumulated in the discharge cells.

In order to address the above-noted problems associated with a strong discharge, a patent document 2 listed below discloses that an auxiliary erase pulse voltage is applied to the scan electrodes after an all-cell reset period ends. As a result, an excessive wall voltage remaining after the reset period is completely erased. With this arrangement, even if a strong discharge occurs, the strong discharge would not adversely affect the subsequent address and sustain periods.

### [Patent Document 1]

JP Patent Application Publication No. 2000-242224

### [Patent Document 2]

JP Patent Application Publication No. 2004-191530

### DISCLOSURE OF THE INVENTION

### Problems the Invention is Attempting to Solve

It should be noted, however, the technique disclosed in the patent document 2 involves the following problems.

First of all, since an auxiliary erase pulse is applied to all the scan electrodes at once after an all-cell erase period, the wall voltage accumulated in all the discharge cells including discharge cells having been properly reset. Consequently, it is inevitable that the margin of voltage for subsequently causing an address discharge becomes narrower.

The term “margin” used herein refers to a range of address voltage values that would substantially cause an address discharge.

A second problem relates to the case where a strong discharge due to an excessive wall voltage occurs in a sub-field of an all-cell reset period in which a sustain discharge is intended to be caused. In this case, application of an auxiliary erase pulse erases not only the excessive wall voltage but also a wall voltage required for causing an address discharge. As a result, it is impossible to cause a sustain discharge in the subsequent sustain period. Therefore, the disclosed technique cannot be practiced without a certain degree of sacrifice of grayscale display quality.

A third problem is that the auxiliary erase pulse used according to the patent document 2 is of a narrow width in order to prevent accumulation of a wall voltage after the erasing (such accumulation tends to cause an erroneous sustain discharge). Naturally, it is difficult to appropriately control such a narrow pulse width. If the pulse width is too narrow, there is a risk that an erase discharge does not occur due to a discharge delay. Without an erase discharge, an excessive wall voltage is not erased. On the other hand, however, if the pulse width is too wide, a wall voltage may be accumulated, which increases the risk of an erroneous sustain discharge. For the reason stated above, it is difficult to ensure a designed margin for each auxiliary erase pulse. In view of the above, it is not desirable to depend on such pulses.

A fourth problem is not associated only with the technique disclosed in the patent document 2 but also with developments of high-definition PDPs having a resolution comparable to full-spec high-vision or higher. In order to increase the definition of a PDP, it is required to dispose discharge cells at a pitch smaller than a conventional pitch. Thus, the distance between the discharge space and the barrier ribs is made relatively shorter. As a consequence, the discharge space is smaller in volumetric capacity. With this being a situation, when driving a PDP of such a structure, priming particles migrating in the discharge space tend to be coupled to charges accumulated on the barrier ribs at a higher percentage as compared with a conventional structure. This lease to a higher risk of larger discharge delay and occurrence of a strong discharge in a reset period.

As described above, conventional methods of driving a PDP involves a problems to be solved regarding an erroneous reset discharge that may occur in the reset period.

The present invention is made in view of the above problems and aims to provide a plasma display panel and a method for driving the plasma display panel capable of image display with no flickering and good quality. These advantageous effects are achieved even if the plasma display panel is in compliance with the high-definition standard and without applying an auxiliary erase pulse after the erase period. More specifically, the advantageous effects are achieved by suppressing problems caused by an erroneous sustain discharge resulting from a strong discharge that may accidentally occur in the reset period.

### Means for Solving the Problems

In order to solve the above-noted problems associated with the prior art, the present invention provides a method for driving a plasma display apparatus through a driving process according to which each of a plurality of fields includes a plurality of sub-fields. The plasma display apparatus has: display electrode pairs each composed of a scan electrode and a sustain electrode; a plurality of address electrodes that are separated from the display electrode pairs by a discharge space and that extend in a direction intersecting the display electrode pairs; and a plurality of discharge cells formed at locations corresponding to the intersections. According to the method, at least one sub-field in each field includes an all-cell reset period in which an erase discharge is caused in all the discharge cells. The all-cell reset period includes: a first step of applying an ascending ramp waveform voltage to the scan electrodes, so that a first reset discharge is caused between each of the scan electrodes and a corresponding one of the data and/or sustain electrodes; a second step of applying a descending ramp waveform voltage to the scan electrodes, so that a second reset discharge is caused between each of the scan electrodes and a corresponding one of the data and/or sustain electrodes; and an excessive wall voltage erase step of applying, after the first step ends, a potential-change waveform to at least either the scan electrodes, the sustain electrodes, or the address electrodes, so that an excessive wall voltage in each discharge cell is erased, the potential-change waveform having a ramp that is steeper than the descending ramp of the waveform voltage applied in the second step to the scan electrodes.

The potential-change waveform may be a pulsed waveform. Further, the potential-change may be applied to the scan electrodes. Further, a potential of the sustain electrodes may be made to change during or after application of the potential-change waveform to the scan electrodes.

Alternatively, the potential-change waveform may be applied to the sustain electrodes. In this case, the potential-change waveform may be applied to the sustain electrodes after the first step ends and before a potential of the scan electrodes changes. Alternatively, the potential-change waveform may be applied to the sustain electrodes after the first step ends and after a potential of the scan electrodes changes.

Alternatively, the potential-change waveform may be applied to the address electrodes. In this case, the address electrodes may act as positively charged electrodes during the potential-change waveform application.

The potential-change waveform may be applied to the address electrodes either before or after a potential of the sustain electrodes changes.

Alternatively, the potential-change waveform may be applied to the scan and sustain electrodes. In this case, the potential-change waveform may be applied to the sustain electrodes either during or after application of the potential-change waveform to the scan electrodes.

Alternatively, the potential-change waveform may be applied to the scan and address electrodes. In this case, the potential-change waveform may be applied to the address electrodes during the potential-change waveform application to the scan electrode and before the potential-change waveform application to the sustain electrodes.

Further, the potential-change waveform may be applied to the address electrodes, so that the address electrodes act as positively charged electrodes or negatively charged electrodes. The potential-change waveform may be applied to the address electrodes during the potential-change waveform application to the scan electrodes and after the potential-change waveform application to the sustain electrodes. Further, the potential-change waveform may be applied to the address electrodes, so that the address electrodes act as positively charged electrodes or negatively charged electrodes.

Alternatively, the potential-change waveform may be applied to the sustain and address electrodes. In this case, the potential-change waveform may be applied so as to change a potential of the address electrodes during the potential-change waveform application to the sustain electrodes. Further, the potential-change waveform may be applied to the address electrodes, regardless of whether the address electrodes act as cathodes or anodes relative to the scan and sustain electrodes.

Further, the potential-change waveform may be applied so as to change a potential of the sustain electrodes during the potential-change waveform application to the address electrodes. The potential-change waveform may be applied to the sustain electrodes, regardless of whether the sustain electrodes act as anodes or cathodes relative to the scan and address electrodes.

According to the driving method according to the present invention, in addition, when an APL of an image to be displayed is lower than a predetermined value, a decreased number of subfields may include a step in which the all-cell reset is performed. On the other hand, when the APL of the image to be displayed is higher than a predetermined value, an increased number of subfields may include a step in which the all-cell reset is performed.

In another aspect, the present invention provides a plasma display panel apparatus including: a plasma display panel unit; and a drive unit connected to the plasma display panel unit. The drive unit is operable to drive the plasma display panel unit according to any of driving methods mentioned above.

### EFFECTS OF THE INVENTION

According to the driving method of the present invention with the above features, a PDP is driven by a method having the excessive wall voltage erase step provided between the first and second steps of an all-cell reset period. In the excessive wall voltage erase step, a potential change waveform (voltage change pulse) that ascends or descends is applied to, for example, the scan electrodes.

With use of the potential change waveform, even if a strong discharge accidentally occurs in some discharge cells in the first step of the reset period and thus an excessive wall voltage is accumulated in the discharge cells, the excessive wall voltage is actively erased before the second step of the reset period starts. Consequently, undesirable occurrence of a strong discharge in the second step of the all-cell reset period is prevented. That is to say, it is ensured to prevent occurrence of such an erroneous discharge that would cause an effect similar to that of an address discharge at the end of the all-cell reset period. With no undesirable discharge occurred in the sustain period in the sub-field, image display is provided with no flickering and good quality.

Unlike the conventional technique, in addition, the present invention applies no erase pulse after the second step of the reset period ends, so that no influence is imposed on the wall voltage accumulated in the normally reset discharge cells. This prevents narrowing of an address margin. Consequently, image degradation owing to an addressing error is suppressed and the PDP is allowed to exhibit good image display performance.

According to the present invention, in addition, an excessive wall voltage undesirably induced in some discharge cells is erased before transition to the second step of the reset period. This allows those discharge cells to be normally reset in the second step of the reset period, so that an address discharge is subsequently caused as necessary. That is to say, an excessive wall voltage is erased without sacrificing the quality of grayscale display. As a result, the PDP is allowed to exhibit good image display performance. In other words, according to the driving method of the present invention, an excessive wall voltage erase step is provided to reliably erase an excessive wall voltage accidentally induced in some discharge cells during the first step of the reset period. The excessive wall voltage is erased before application of a descending ramp waveform (in the second step of the reset period). The excessive wall voltage would cause a strong discharge in the discharge cells. That is, the excessive wall voltage erase step acts as a trap, in the second step of the reset period, for a strong discharge that would cause an effect similar to that of an address discharge. That is to say, provision of the excessive voltage erase period does not affect discharge cells with no excessive wall voltage that would cause a strong discharge. In those normally reset cells, the state of wall voltage undergoes no change throughout the excessive wall voltage erase step and thus an address discharge can be appropriately caused.

With the above advantages, all the discharge cells has an appropriate level of wall voltage, so that an address discharge in the address period subsequent to the second step of the reset period is timely caused. This prevents a discharge delay and ensures appropriate occurrence of a sustain discharge. Consequently, according to the present invention, an address discharge is caused appropriately, so that a design margin is ensured relatively easily without sacrificing grayscale quality, as compared with the technique disclosed in the patent document 2.

As stated above, the present invention ensures that the wall voltage in each discharge cell is adjusted to an appropriate level. This advantageous effect is achieved even with a high-definition PDP having a resolution comparable to full-spec high-vision or higher. Generally, the discharge space of such a PDP is smaller in volumetric capacity, so that priming particles migrating in the discharge space tend to be coupled to charges accumulated on the barrier ribs. Yet, according to the present invention, the wall voltage is adjusted to an appropriate level. That is to say, the present invention is capable of preventing occurrence of a discharge delay and strong discharge, thereby enabling the PDP, regardless of its standard, to exhibit excellent image display performance.

### BRIEF DESCRIPTION OF THE DRAWINGS

FIG. 1 is an oblique view of an exemplary surface discharge type AC PDP;

FIG. 2 is a view schematically illustrating an electrode arrangement of the exemplary PDP;

FIG. 3 is a block diagram of a PDP apparatus driven by an exemplary PDP driving method;

FIG. 4 is a view illustrating drive waveforms applied to the respective electrodes of the exemplary PDP;

FIG. 5 is a view illustrating problems associated with an exemplary driving method;

FIG. 6 are views illustrating drive waveforms according to an embodiment 1 of the present invention;

FIG. 7 is a view illustrating sub-field patterns used in a driving method according to the embodiment 1;

FIG. 8 are views illustrating drive waveforms according to an embodiment 2 of the present invention;

FIG. 9 are views illustrating drive waveforms according to an embodiment 3 of the present invention;

FIG. 10 are views illustrating drive waveforms according to an embodiment 4 of the present invention;

FIG. 11 are views illustrating drive waveforms according to an embodiment 5 of the present invention; and

FIG. 12 are views illustrating drive waveforms according to an embodiment 6 of the present invention.

### REFERENCE NUMERALS

1 PDP
2 Front Substrate
3 Back Substrate
6 Dielectric Layer
7 Protective Layer
8 Insulating Layer
10 Barrier Ribs
11 Phosphor Layer
12 Address Electrode Driving Circuit
13 Scan Electrode Driving Circuit
14 Sustain Electrode Driving Circuit
15 Timing Signal Generating Circuit
16 A/D Converter
17 Scan Number Converter
18 Sub-Field Converter
19 APL Detector
D1-Dm Address Electrodes
SCN1-SCNn Scan Electrodes
SUS1-SUSn Sustain Electrodes

### BEST MODE FOR CARRYING OUT THE INVENTION

The following describes embodiments of the present invention with reference to the accompanying drawings.

### EMBODIMENT 1

### (Overall Structure of PDP Apparatus)

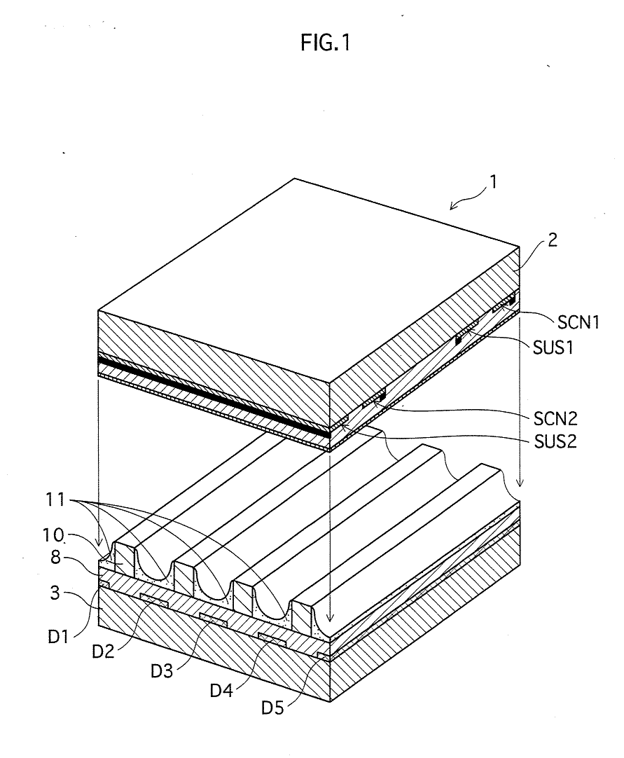

FIG. 1 is a partial oblique view of an exemplary PDP structure. A PDP 1 illustrated in the figure is generally identical to the conventional structure described above. Thus, overlapping descriptions will be omitted. It should be noted, in addition, that the PDP and the drive device of the substantially same structures are employed throughout all the embodiments below.

The PDP 1 includes a front substrate (front panel) 2 and a back substrate (back panel) 3 and a main part of each substrate is constituted of a grass panel. The substrates 2 and 3 are arranged face to face via a discharge space formed therebetween.

On one main surface of the front substrate 2, a plurality of scan electrodes SCN1-SCNn and sustain electrodes SUS1-SUSn are arranged alternately in parallel to one another. Each scan electrode makes up a display electrode pair with a corresponding sustain electrode. In a manner to entirely cover the scan electrodes SCN1-SCNn and the sustain electrodes SUS1-SUSn, a dielectric layer 6 and a protective layer 7 are laminated in the stated order.

For the sake of a stable discharge, the protective layer 7 is preferably made of a material exhibiting a high secondary electron emission coefficient and a high sputtering resistance. For example, the protective layer 7 is made of an MgO thin film.

On the back substrate 3, a plurality of address electrodes D1-Dm are arranged in parallel and an insulating layer 8 is disposed to cover the address electrodes. In addition, barrier ribs 10 are disposed on the insulating layer 8 at locations in parallel to the address electrodes D1-Dm. Red (R), green (G), and blue (B) phosphors are separately applied into grooves formed between adjacent barrier ribs 10 in a manner to cover corresponding surfaces of the insulating layer 8. In this way, the phosphor layers 11 of respective colors are disposed in parallel.

The red phosphor may be composed of either or a combination of (Y, Gd)BO₃:Eu, Y₂O₃:Eu, and YVO₃:Eu.

The green phosphor may be composed of either or a combination of Zn₂SiO₄:Mn, (Y, Gd)BO₃:Tb, and BaAl₁₂O₁₉:Mn.

The blue phosphor may be composed of either or a combination of BaMgAl₁₀O₁₇:Eu and CaMgSi₂O₆:Eu.

The front substrate 2 and the back substrate 3 are so disposed that the address electrodes D1-Dm face toward the scan electrodes SCN1-SCNn and the sustain electrodes SUS1-SUSn via a space present between the respective substrates. This space serves as a discharge space and filled with a discharge gas. For example, the discharge gas is a mixture of He, Ne, Xe, and the like. A plurality of discharge cells are formed in matrix along the flat surfaces of the panels. More specifically, the discharge cells are formed at locations at which the address electrodes D1-Dm intersect the pairs of display electrode pairs in plan view.

With the PDP 1 having the above-structure, a gas discharge is caused in the discharge cells to generate ultraviolet radiation. Being excited by the ultraviolet radiation, the phosphor layers 11 emit light. Since the phosphor layers 11 are so arranged that the three primary colors of RGB are adjacent to one another, color image display is achieved.

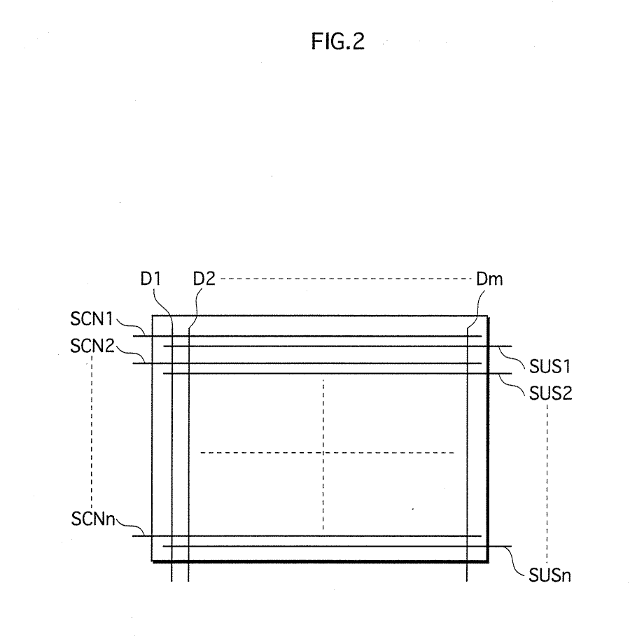

FIG. 2 is a view schematically illustrating an electrode arrangement of the PDP 1. As illustrated in the figure, the PDP 1 includes n scan electrodes SCN1-SCNn and n sustain electrodes SUS1-SUSn that are alternately arranged in the row direction. In the column direction, m address electrodes D1-Dm are arranged. A discharge cell is formed at each location where a pair made of a scan electrode SCNi and a sustain electrode SUSi (i ranges from 1 to n) intersects with an address electrode Dj (j ranges from 1 to m). Thus, there are m×n discharge cells formed within the discharge space.

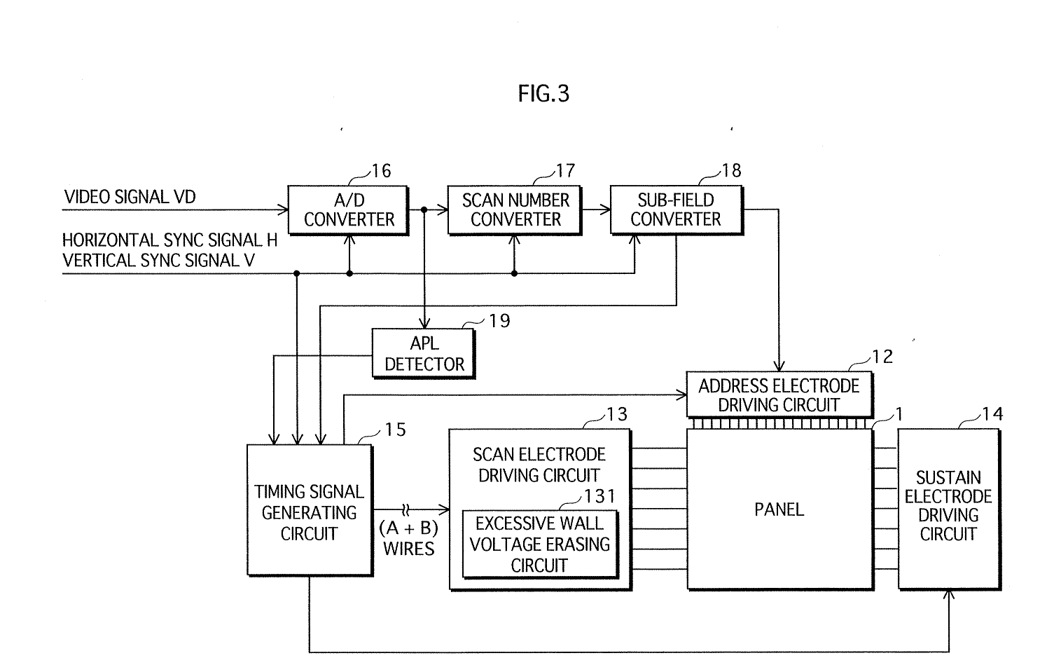

FIG. 3 is a block diagram of a PDP apparatus composed of the PDP 1 and driving circuits connected to the respective electrodes SCN1-SCNn, SUS1-SUSn, and D1-Dm.

The PDP apparatus is generally of a known structure. As illustrated in the figure, the PDP apparatus is composed of the PDP (panel) 1, an address electrode driving circuit 12, a scan electrode driving circuit 13, a sustain electrode driving circuit 14, a timing signal generating circuit 15, an A/D (analog to digital) converter 16, a scan number converter 17, a sub-field converter 18, an APL (Average Picture Level) detector 19, and a power circuit (not illustrated).

In FIG. 3, a video signal VD is supplied to the A/D converter 16. On the other hand, a horizontal sync signal H and a vertical sync signal V are supplied to the timing signal generating circuit 15, the A/D converter 16, and the scan number converter 17.

The A/D converter 16 converts the video signal VD into a digital signal representing an image and outputs the image data to the scan number converter 17 and the APL detector 19.

The scan number converter 17 converts the image data into a plurality of pieces of image data correspondingly to the number of pixels of the PDP 1 and outputs the resulting pieces of image data to the sub-field converter 18. The sub-field converter 18 divides each piece of image data of one pixel into a plurality of bit groups correspondingly to a plurality of sub-fields. Then, the sub-field converter 18 outputs, to the address electrode driving circuit 12, the resulting image data on a group-by-group basis correspondingly to the sub-fields.

The APL detector 19 detects an average luminance level of an image (hereinafter “APL”).

The timing signal generating circuit 15 controls the drive waveform based on an APL output from the APL detector 19. More specifically, the timing signal generating circuit 15 selects, in a later described manner, either of an all-cell reset operation and a selective reset operation for each of the plurality of sub-fields constituting one field. The selection is made based on the APL of that field. In this way, the number of times of the all-cell reset operation to be performed in one field is controlled. The timing signal generating circuit 15 supplies a timing signal to the scan electrode driving circuit 13 via (a+b) pieces of wire. Here, out of the (a+b) pieces, the b pieces of wire are used for controlling the potential change during an excessive wall voltage erase step, which will be described later.

The scan electrode driving circuit 13 supplies a drive waveform to the scan electrodes SCN1-SCNn in accordance with the timing signal. As illustrated in FIG. 3, the scan electrode driving circuit 13 includes an excessive wall voltage erase circuit 131 that applies a potential change waveform (voltage change pulse) having a rise or fall to the scan electrodes SCN1-SCNn in the excessive wall voltage erase step. The potential change waveform is applied in accordance with the timing signal supplied via the b pieces of wire.

Note that the excessive wall voltage erase circuit 131 may be provided in the address electrode driving circuit 12 or the sustain electrode driving circuit 14, rather than in the scan electrode driving circuit 13.

The sustain electrode driving circuit 14 supplies a drive waveform to the sustain electrodes SUS1-SUSn, in accordance with the timing signal.

The address electrode driving circuit 12 sequentially converts pieces of image data each of which is worth one sub-field into signals corresponding to the respective address electrodes D1-Dm and drives the address electrodes accordingly. The timing signal generating circuit 15 generates a timing signal based on the horizontal sync signal H and the vertical sync signal V and outputs the generated timing signal to the scan electrode driving circuit 13 and the sustain electrode driving circuit 14.

### (PDP Driving Method)

According to a driving method employing the known sub-field method, the PDP apparatus is driven by repeating a cycle of a reset period, an address period, and a sustain period. The following sequentially describes the respective periods.

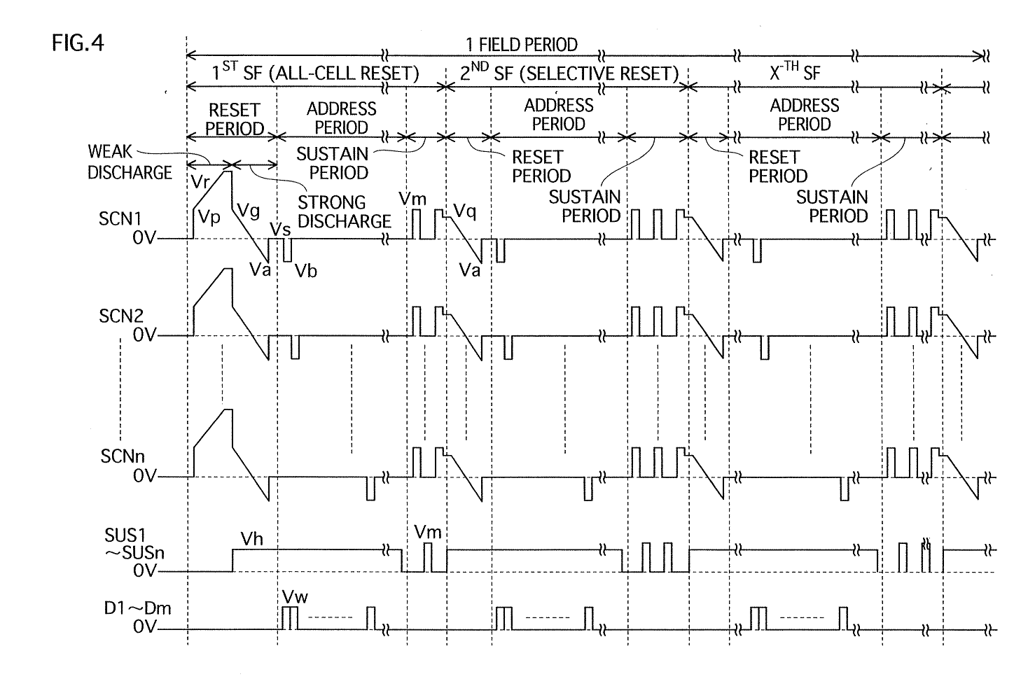

FIG. 4 is a view illustrating the drive waveforms.

### (a) Reset Period

In each reset period, either of the following two drive waveforms is selectively applied: one is a drive waveform to be applied in an all-cell reset sub-field and the other is a drive waveform to be applied in a selective reset sub-field.

(a-1) All-Cell Reset Sub-Field

A reset operation performed in an all-cell reset sub-field is to cause a reset discharge in all the discharge cells at once. With this reset operation, a wall voltage having been accumulated in the respective discharge cells is erased and a necessary level of wall voltage for a subsequent address operation is newly accumulated in the respective discharge cells. In addition, the reset operation serves to generate priming (initiator of the discharge=excited particles). The priming serves to reduce discharge delay and ensures an address discharge to stably occur.

An all-cell reset period is divided into the following two periods. One period is a first step and the period other is second step.

One feature of the embodiment 1 lies in that another step is additionally provided between the fast and second steps. Yet, a description of the additional period will be described later in detail.

As illustrated in FIG. 4, during the first step of a reset period, the sustain electrodes SUS1-SUSn and the address electrodes D1-Dm are maintained at 0 (V). In addition, a ramp voltage is applied to the scan electrodes SCN1-SCNn. The ramp voltage applied herein has a waveform that gently ascends from a voltage Vp (V) to a voltage Vr (V). The voltage Vp (V) is equal to or lower than the firing voltage, whereas the voltage Vr (V) exceeds the firing voltage.

With the application of the ascending ramp voltage, a weak reset discharge is caused in all the discharge cells. During the reset discharge, the scan electrodes SCN1-SCNn act as anodes, whereas the sustain electrodes SUS1-SUSn and the address electrodes D1-Dm act as cathodes.

In the above described manner, a weak reset discharge is caused in all the discharge cells for the first time. As a result, a negative wall voltage is accumulated on the scan electrodes SCN1-SCNn. In addition, a positive wall voltage is accumulated on the sustain electrodes SUS1-SUSn as well as on the address electrodes D1-Dm. To be more precise, a wall voltage accumulated on the respective electrodes refers to the voltage resulting from the wall voltage that is accumulated on the dielectric and phosphor layers covering the respective electrodes. In the first step of the reset period, a weak discharge is caused in all the discharge cells, irrespective of whether or not a sustain discharge occurred in the immediately previous sub-field.

On the other hand, in the second step of the reset period, the sustain electrodes SUS1-SUSn are maintained at a voltage Vh (V). In addition, a ramp voltage is applied to the scan electrodes SCN1-SCNn. The ramp voltage applied herein has a waveform that gently descends from a voltage Vg (V) to a voltage Va (V). With the application of the descending ramp voltage, a weak reset discharge occurs for the second time in all the discharge cells. During the second weak reset discharge, the scan electrodes SCN1-SCNn act as cathodes, whereas the sustain electrodes SUS1-SUSn and the address electrodes D1-Dm act as anodes. As a result, the wall voltage having been accumulated on the scan electrodes SCN1-SCNn and the sustain electrodes SUS1-SUSn is reduced. In addition, the wall voltage accumulated on the address electrodes D1-Dm is adjusted to a level appropriate for performing an address operation in the subsequent address period, which will be described later.

(a-2) Selective Reset Sub-Fields

In a selective reset sub-field, a reset discharge is caused selectively in discharge cells in which a sustain discharge occurred in the immediately previous sub-field.

The following describes drive waveforms applied in a selective reset sub-field and the operation performed in the sub-field.

In a selective reset sub-field, the sustain electrodes SUS1-SUSn are maintained at the voltage Vh (V), and the address electrodes D1-Dm are maintained at 0 (V). In addition, a ramp voltage is applied to the scan electrodes SCN1-SCNn. The ramp voltage applied herein has a waveform that gently descends from a voltage Vq (V) to the voltage Va (V). With application of the descending ramp voltage, a weak reset discharge is caused in the discharge cells in which a sustain discharge occurred in the immediately previous sub-field. As a result, a wall voltage accumulated on the scan electrode SCNi and the sustain electrode SUSi is reduced. In addition, a wall voltage accumulated on the address electrode Dk is adjusted to a level appropriate for performing an address operation in the subsequent address period. On the other hand, in the other discharge cells in which no address discharge and no sustain discharge occurred in the immediately previous sub-field, no discharge is caused in this sub-field. Thus, the state of wall voltage undergoes no change and thus maintained as it is from the time at which the reset period ends in the immediately previous sub-field.

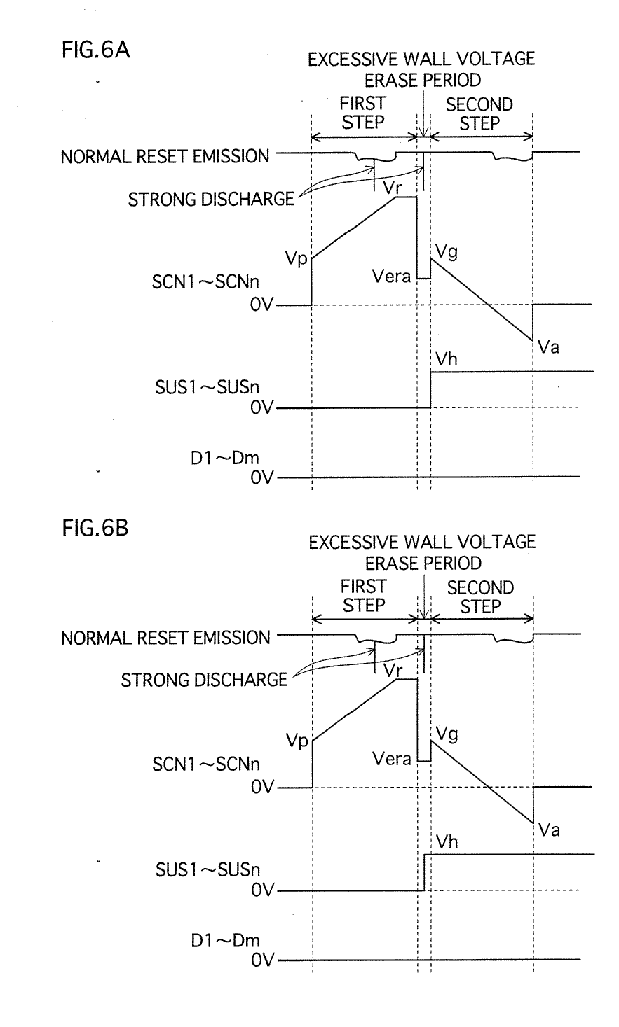

As illustrated in FIG. 6, one feature of the embodiment 1 lies in that an excessive wall voltage erase step is provided between the first and second steps of an all-cell reset period. In the excessive wall voltage erase step, a potential change waveform (voltage change pulse) having a rise or fall is applied to the scan electrodes SCN1-SCNn. The following describes this feature, with reference to FIG. 6A.

Generally, in the first step of a reset period, the sustain electrodes SUS1-SUSn and the address electrodes D1-Dm are maintained at 0 (V). In addition, a ramp voltage is applied to the scan electrodes SCN1-SCNn. The ramp voltage applied herein has a waveform that gentry ascends from the voltage Vp (V) to the voltage Vr (V). The voltage Vp (V) is equal to or lower than the firing voltage, whereas the voltage Vr (V) exceeds the firing voltage. With application of the rising ramp voltage, the scan electrodes SCN1-SCNn act as anodes, whereas the sustain electrodes SUS1-SUSn and the address electrodes D1-Dm act as cathodes. As a result, a weak reset discharge occurs for the first time in all the discharge cells. With occurrence of the first weak reset discharge, a negative wall voltage is accumulated on the scan electrodes SCN1-SCNn, whereas a positive wall voltage is accumulated on the sustain electrodes SUS1-SUSn and the address electrodes D1-Dm.

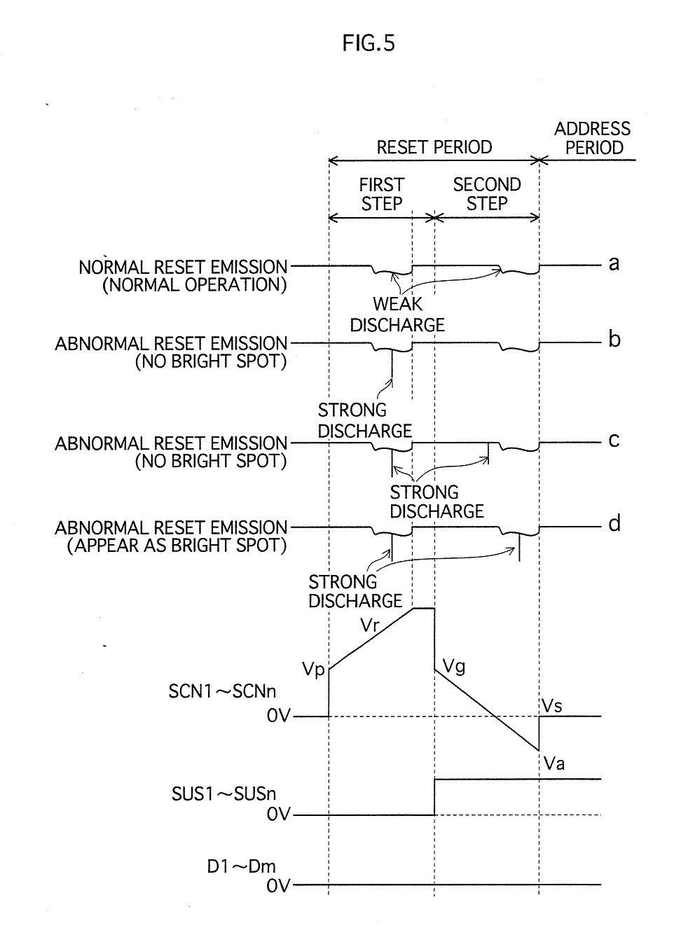

According to the recent year's study, the partial pressure of Xe in the discharge gas sealed within the PDP is increased to improve the luminous efficiency. It should be noted, however, that discharge delay increases with the Xe partial pressure (for example, in the case where the Xe partial pressure is set to be 7% or higher). The discharge delay is problematic especially when there is an insufficient amount of priming. In such a case, there is a risk that a strong discharge, rather than a weak discharge, accidentally occurs in some discharge cells (abnormal reset emission) (FIG. 5, lines “b” to “d”). If a strong discharge occurs in the second step in which a descending ramp waveform is applied (FIG. 5, line “d”), the strong discharge produces an effect substantially identical to an address discharge before an address discharge actually takes place. With this being a situation, it is no longer possible to control a sustain discharge and thus image degradation is inevitable.

The above-noted problem associated with a strong discharge arises even if the sustain electrodes SUS1-SUSn, each of which serves as a cathode in the second step of the reset period, are covered with the protective layer 7 having a high secondary electron emission coefficient. In addition, such an abnormal reset emission may be caused due to the factors other than the Xe partial pressure. For example, such an abnormal reset light emission may be caused depending on the electron emission coefficient of the phosphor layers or the state of wall voltage accumulated in the discharge cells.

The problem associated with a strong discharge may be solved by a known technique disclosed, for example, in the patent document 2. According to the patent document 2, after an all-cell reset period, an auxiliary erase pulse is applied to the scan electrodes to erase an excessive wall voltage. Yet, this solution is not desirable because of adverse effect on the wall voltage accumulated in discharge cells that are normally reset. This leads to various problems. For example, an address margin becomes narrower or the quality of grayscale display is sacrificed for an erasing excessive wall voltage.

In view of the above, the present invention provides an excessive wall voltage erase step after the first step of the reset period. In the excessive wall voltage erase step, a voltage Vera (V) is applied to the scan electrodes SCN1-SCNn. The voltage Vera (V) has such a value that each discharge cell normally reset in the first step of the reset period would not reach the firing voltage. Subsequently to the voltage Vera (V), the voltage Vg (V) is applied to the scan electrodes SCN1-SCNn at the start of the second step.

With provision of such an excessive wall voltage erase step, an excessive wall voltage is erased before transition to the second step of the all-cell reset period. In addition, the erasing takes place only in the discharge cells in which a strong discharge occurred in the first step of the all-cell reset period and thus excessive wall voltage has been accumulated. The excessive wall voltage erase step prevents premature occurrence of a substantial address discharge in the second step of the reset period.

The excessive wall voltage erase step is a period for causing an erase discharge to erase an excessive wall voltage accumulated in the discharge cells in which a strong discharge occurred during the first step of the reset period. Since the excessive wall voltage erase step immediately follows the first step of the reset period, there is an advantage that a time period taken for reliably causing an erase discharge is relatively short since delay of an erase discharge is kept relatively small at this stage. This is because there is a sufficient amount of priming generated by a strong discharge caused in the discharge cell and by a weak discharge caused in adjacent discharge cells during the first step of the reset period. With the above-noted advantage, a design margin of an erase period is ensured relatively easily.

With the above advantages, the present invention appropriately solves problems related to the discharge delay, even in the case where the partial pressure of Xe in the discharge gas is 7% or higher.

Furthermore, with provision of an excessive wall voltage erase step, the present invention is suitably applicable to a high definition PDP having a discharge space that is smaller than the conventional standards and has a resolution comparable to HD (High Definition) or higher. Generally, at the time of driving a PDP of such a structure, priming particles tend to be coupled to charges accumulated on the barrier ribs. Yet, according to the present invention, the wall charges are appropriately adjusted.

For the reasons stated above, the present invention is applicable to manufacturing of high definition PDPs. The PDPs according to the present invention are enabled to prevent occurrences of problems associated with discharge delay and strong discharge and to exhibit good image display performance.

In addition, according to the present invention, the pulse applied in the excessive wall voltage erase step acts as a trap for a strong discharge possible in the second step of the reset period. Thus, no influence is exerted on discharge cells having been reset normally since those discharge cells are without excessive wall voltage that would cause a strong discharge. With this advantage, even if the excessive wall voltage erase step is provided in the all-cell reset period, the present invention is free from the problems associated with the patent document 2. According to the present invention, the all-cell reset period has no influence on the wall voltage accumulated in the discharge cells, so that the address margin is prevented from being narrower.

According to, in addition, the excessive wall voltage generated as a result of a strong discharge caused in the first step of an all-cell reset period is erased before transition to the second step. This ensures that the discharge cells are normally reset in the second step. Consequently, a subsequent address discharge is ensured to occur property. Thus, unlike the patent document 2, the present invention ensures image display of good quality without compromising grayscale quality.

In addition, the PDP described in the embodiment 1 has the R, G, and B phosphor layers containing phosphors that tend to be charged negatively, such as YVO₃:Eu, Zn₂SiO₄:Mn, CaMgSi₂O₆:Eu. In such a case, a strong discharge in an all-cell reset period occurs more easily. The inventors of the present invention have confirmed by experiment that the drive method of the present invention works even more effectively in such a case.

In each discharge cell in which an excessive wall voltage is accumulated on the scan electrode SCNi, the sustain electrode SUSi, and the address electrode Dj, application of the voltage Vera (V) to the scan electrodes SCN1-SCNn will cause the voltage to exceed the firing voltage (Vf) and a strong discharge occurs in the discharge cell. As a result, the wall voltage accumulated on the scan electrode SCNi, the sustain electrode SUSi, and the address electrode Dj is reversed, whereby the wall voltage in the discharge cells are erased. The value of voltage Vera (V) varies depending on the Xe partial pressure. Thus, it is necessary to determine the voltage Vera (V) to such a value that would cause a discharge only in the discharge cells in which an excessive wall voltage is accumulated in the first step of the reset period.

Furthermore, an excessive wall voltage erase step should be set to a necessary duration (0.5 μs to 50 μs, for example) for reliably causing an erase discharge even with discharge delay.

In the second step of the reset period, the sustain electrodes SUS1-SUSn are maintained at the voltage Vh (V). In addition, a ramp voltage is applied to the scan electrodes SCN1-SCNn. The ramp voltage applied herein has a waveform that gently descends from the voltage Vg (V) to the voltage Va (V). With application of the descending ramp voltage, a weak reset discharge occurs for the second time in all the discharge cells (including discharge cells in which a discharge occurred in the excessive wall voltage erase step). During the second weak discharge, the scan electrodes SCN1-SCNn act as cathodes, whereas the sustain electrodes SUS1-SUSn and the address electrodes D1-Dm act as anodes. As a result, the wall voltage accumulated on the scan electrodes SCN1-SCNn and the sustain electrodes SUS1-SUSn is reduced. In addition, the wall voltage accumulated on the address electrodes D1-Dm is adjusted to a level appropriate for performing an address operation in the subsequent address period.

### (b) Address Period

The following describes the drive waveforms and the operation performed in the address period.

As illustrated in FIG. 4, in the address period subsequent to the reset period, the scan electrodes SCN1-SCNn are temporarily maintained at the voltage Vs (V). Next, among the address electrodes D1-Dm, an address pulse voltage Vw (V) is applied to the address electrode Dk that corresponds to the first row of discharge cells to be displayed. In addition, a scan pulse voltage Vb (V) is applied to the first scan electrode SCN1. As a result, the voltage at the intersection of the address electrode Dk and the scan electrode SCN1 becomes a sum of the externally applied voltage (Vw and Vb) and the wall voltage accumulated on the address electrode Dk and the scan electrode SCN1. Since the sum exceeds the firing voltage, an address discharge occurs between the address electrode Dk and the scan electrode SCN1 as well as between the sustain electrode SUS1 and the scan electrode SCN1. Thus, in the discharge cell, a positive wall voltage is accumulated on the scan electrode SCN1, and a negative wall voltage is accumulated on the sustain electrode SUS1. In addition, a negative wall voltage is also accumulated on the address electrode Dk. In this way, an address operation is performed to cause an address discharge in the discharge cell in the first row to accumulate a wall voltage on the respective electrodes.

On the other hand, the voltage at each intersection of the scan electrode SCN1 and the address electrodes to which no address pulse voltage Vw (V) is applied does not exceed the firing voltage. Thus, no address discharge is caused there.

The above address operation is repeated on the discharge cells up to the n-th row and then the address period ends. As described above, in the address period, a scan pulse is applied sequentially to the scan electrodes, and an address pulse voltage is applied sequentially to appropriate address electrodes in accordance with the image signal to be displayed. In this way, an address discharge is caused between the scan electrodes and the selected address electrodes to generate a wall voltage in the selected discharge cells.

### (c) Sustain Period

Next, a description is given of the drive waveforms applied in a sustain period and operation performed in the sustain period.

As illustrated in FIG. 4, in the sustain period subsequent to the address period, the sustain electrodes SUS1-SUSn are reset to 0 (V). Then, a sustain pulse voltage Vm (V) is applied to the scan electrodes SCN1-SCNn.

At this time, in each discharge cell in which an address discharge has occurred, the voltage between the scan electrode SCNi and the sustain electrode SUSi is a sum of the sustain pulse voltage Vm (V) and the wall voltage accumulated on the scan electrode SCNi and the sustain electrode SUSi. Since the sum exceeds the firing voltage, a sustain discharge occurs between the scan electrode SCNi and the sustain electrode SUSi. As a result, a negative wall voltage is accumulated on the scan electrode SCNi, and a positive wall voltage is accumulated on the sustain electrode SUSi. In addition, a positive wall voltage is also accumulated on the address electrode Dk. On the other hand, a sustain discharge does not occur in the discharge cells in which no address discharge occurred in the address period. Thus, the wall voltage undergoes no change and the state observed at the end of reset period is maintained.

Next, the scan electrodes SUS1-SUSn are reset to 0 (V), and the positive sustain pulse voltage Vm (V) is applied to the sustain electrodes SUS1-SUSn. With application of the sustain voltage, in each discharge cell in which a sustain a discharge has occurred, the voltage between the sustain electrode SUSi and the scan electrode SCNi exceeds the filing voltage. Thus, a sustain discharge occurs again between the sustain electrode SUSi and the scan electrode SCNi. As a result, a negative wall voltage is accumulated on the sustain electrode SUSi and a positive wall voltage is accumulated on the scan electrode SCNi. Thereafter, a sustain pulse is applied alternately to the scan electrodes SCN1-SCNn and the sustain electrodes SUS1-SUSn in a similar manner. As a result, a sustain discharge is maintained in each discharge cell in which an address discharge occurred in the previous address period.

At this stage, the number of sustain pulses serves as a weighting factor of luminance. That is to say, by suitably varying the number of sustain pulses applied in each sub-field, the sub-fields in combination realize a desired gray-scale level.

Note that at the end of the sustain period, so-called a narrow width pulse is applied between the respective pairs of scan electrodes SCN1-SCNn and the sustain electrodes SUS1-SUSn. As a result, a wall voltage accumulated on the scan electrodes SCN1-SCNn and the sustain electrodes SUS1-SUSn are erased, while a positive wall voltage accumulated on the address electrode Dk is left unerased.

In a sustain period, a sustain pulse voltage is applied in the above-described manner between the respective pairs of scan and sustain electrodes for a given number of times that is determined according to the luminance weighting factor. As a result, a discharge is caused selectively in the discharge cells in which a wall voltage has been generated through an address discharge, so that the discharge cells emit light.

In the embodiment 1, each drive waveform is described with reference to FIG. 6A. Yet, it is applicable to apply the voltage Vh (V) to the sustain electrodes SUS1-SUSn during the excessive wall voltage erase step, as illustrated in FIG. 6B. By applying a voltage to the scan electrodes SCN1-SCNn as well as to the sustain electrodes SUS1-SUSn during the excessive wall voltage erase step, the voltage between each pair of electrodes increases. As a result, an erase discharge is caused even more reliably.

### Working Examples

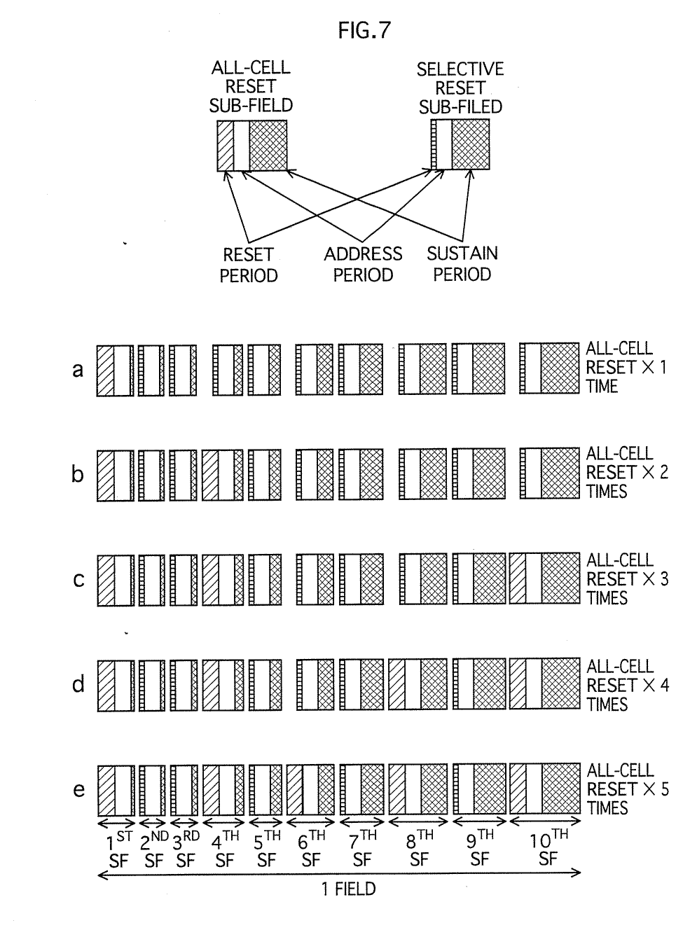

FIG. 7 illustrates an example setting according to the driving method used by the PDP of the embodiment 1 (working example). According to the setting, the sub-field pattern is changed based on the APL of an image signal to be displayed. Specifically, it is the sub-field converter 18 that effects change of the sub-field pattern.

The reference numeral “a” in FIG. 7 denotes the sub-field pattern used when the APL of an image signal to be displayed falls within the range of 0 to 1.5%. According to this pattern, the all-cell reset operation is performed only in the reset period of the 1^{st} SF. In the reset periods of the 2^{nd} to 10^{th} SFs, the selective reset operation is performed.

The reference numeral “b” in FIG. 7 denotes the sub-field pattern used when the APL of an image signal to be displayed falls within the range of 1.5% to 5%. According to this pattern, the all-cell reset operation is performed in the reset periods of the 1^{st} and 4^{th} SFs. In the reset periods of the 2^{nd}, 3^{rd}, and 5^{th} to 10^{th} SFs, the selective reset operation is performed.

The reference numeral “c” in FIG. 7 denotes the sub-field pattern used when the APL of an image signal to be displayed falls within the range of 10% to 15%. According to this pattern, the all-cell reset operation is performed in the reset periods of the 1^{st}, 4^{th}, and 10^{th} SFs. In the reset periods of the 2^{nd}, 3^{rd}, and 5^{th} to 9^{th} SFs, the selective reset operation is performed.

The reference numeral “d” in FIG. 7 denotes the sub-field pattern used when the APL of an image signal to be displayed falls within the range of 10% to 15%. According to this pattern, the all-cell reset operation is performed in the reset periods of the 1^{st}, 4^{th}, 8^{th} and 10^{th} SFs. In the reset periods of the 2^{nd}, 3^{rd}, 5^{th} to 7^{th}, and 9^{th} SFs, the selective reset operation is performed.

The reference numeral “e” in FIG. 7 denotes the sub-field pattern used when the APL of an image signal to be displayed falls within the range of 15% to 100%. According to this pattern, the all-cell reset operation is performed in the reset periods of the 1^{st}, 4^{th}, 6^{th}, 8^{th}, and 10^{th} SFs. In the reset periods of the 2^{nd}, 3^{rd}, 5^{th}, 7^{th}, and 9^{th} SFs, the selective reset operation is performed.

Table 1 below shows the relation between the sub-field patterns and the APLs.

TABLE 1

| | All-Cell Rest Operations | |
|---|---|---|
| APL (%) | (No. of Times) | All-Cell Reset SFs |
| 0-1.5 | 1 | 1 |
| 1.5-5 | 2 | 1, 4 |
| 5-10 | 3 | 1, 4, 10 |
| 10-15 | 4 | 1, 4, 8, 10 |
| 15-100 | 5 | 1, 4, 6, 8, 10 |

### <Consideration>

According to the embodiment 1, the number of times for performing the all-cell reset operation per field is determined depending on the APL.

More specifically, as shown in Table 1, for displaying an image of which APL is high, the all-cell reset operation is performed for an increased number of times. This is because a high APL image has a relatively small black area. With the increase of the number of times of the all-cell reset operations, the amount of priming increases to stably cause a reset discharge and an address discharge. Conversely, an image of which APL is low has a relatively large black area. Thus, the all-cell reset operation is performed for a decreased number of times to improve black display quality.

With the above setting, the PDP apparatus of the working example lowers the luminance of black areas, if the APL is low. This holds irrespective of whether the entire image includes a high-luminance area. As a result, the contrast of display image improves.

In the above working example, one field is composed of ten sub-fields and the all-cell reset operation is performed for 1 to 5 times. It should be naturally appreciated, however, that the present invention is not limited to this specific example.

Tables 2 and 3 below show data of other working examples. In the example shown in Table 2, the all-cell reset operation is controlled to be performed for 1 to 4 times. In addition, the all-cell reset operation is performed in different sub-fields depending on the APL.

In the example shown in Table 3, the all-cell reset operation is controlled to be performed for 1 to 3 times. In addition, the all-cell reset operation is performed in the earlier sub-fields in the field, with priority.

TABLE 2

| | All-Cell Rest Operations | |
|---|---|---|
| APL (%) | (No. of Times) | All-Cell Reset SFs |
| 0-1.5 | 1 | 1 |
| 1.5-5 | 2 | 1, 9 |
| 5-10 | 3 | 1, 4, 9 |
| 10-100 | 4 | 1, 4, 8, 10 |

TABLE 3

| | All-Cell Rest Operations | |
|---|---|---|
| APL (%) | (No. of Times) | All-Cell Reset SFs |
| 0-1.5 | 1 | 1 |
| 1.5-5 | 2 | 1, 4 |
| 5-100 | 3 | 1, 4, 6 |

As described above, although provision of an excessive wall voltage erase step involves a risk that a strong discharge accidentally occurs in the first step of the all-cell reset period, each working example above manages to erase an excessive wall voltage resulting from such a strong discharge. Thus, occurrence of an erroneous discharge in the subsequent sustain period is prevented. In addition, according to the above working examples, an excessive wall voltage is reliably erased before the second step of the reset period ends. This ensures that the wall voltage accumulated in the normally reset discharge cells are not influenced. Thus, the above working examples are free from the problem of a narrower address margin that is associated with the technique disclosed in the patent document 2.

According to the above working examples, in addition, an excessively accumulated wall voltage is erased immediately after the first step of the reset period. This allows a normal reset discharge to be occurred in the second step of the reset period. Consequently, an address discharge in the subsequent address period occurs normally. In this manner, unlike the technique disclosed in the patent document 2, each working example ensures display of good quality images without sacrificing the gray-scale quality.

In addition, an erase discharge in the excessive wall voltage erase step occurs immediately after the first step of the reset period. Thus, the discharge delay is relatively small owing to the sufficient amount of priming resulting from the strong discharge accidentally occurred in the first step and from a weak discharge occurred in the adjacent discharge cells. Thus, a time period necessary for ensuring occurrence of an erase discharge is shorter. This advantage allows the design margin of an erase period to be ensured relatively easily, as compared with the technique disclosed in the patent document 2.

### Embodiment 2

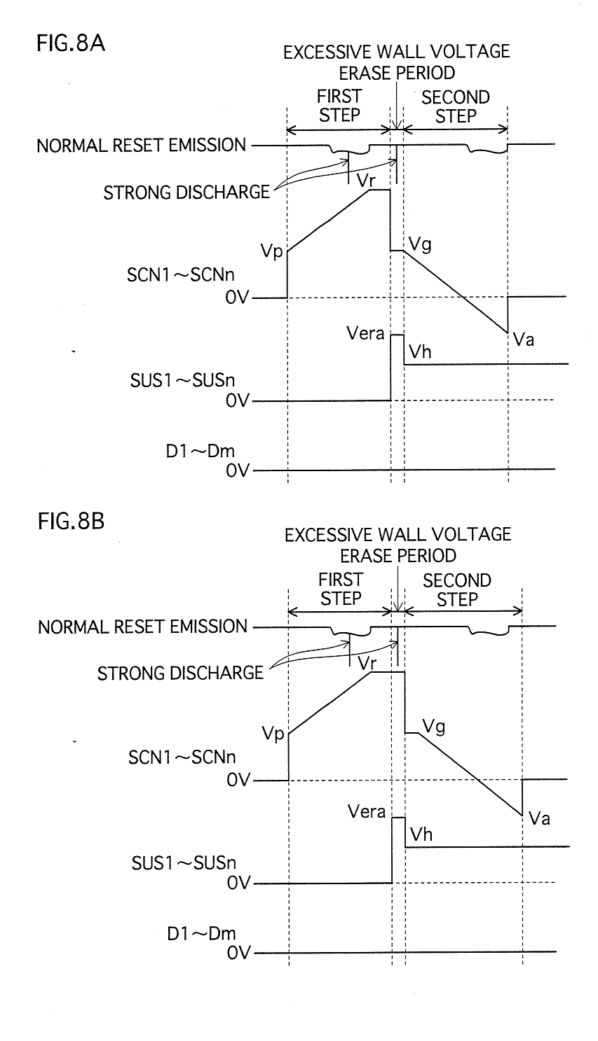

FIG. 8 illustrate drive waveforms applied in the all-cell reset period for driving a PDP according to an embodiment 2 of the present invention.

The embodiment 2 is based on the drive waveforms illustrated in FIG. 4 applied to the respective electrodes of a typical PDP. One feature of the embodiment 2 lies in that an excessive wall voltage erase step is provided between the first and second steps of an all-cell reset period as illustrated in FIG. 8. In the excessive wall voltage erase step, a potential change waveform (voltage change pulse) that rises or falls is applied to the sustain electrodes SUS1-SUSn.

Regarding the first and second steps of a reset period, the embodiment 2 employs the same sub-field pattern as the embodiment 1. Thus, a description thereof is omitted. The description below relates to the excessive wall voltage erase step that is different from the embodiment 1.

In FIG. 8A, after the first step of the reset period ends, the voltage Vg (V) is applied to the scan electrodes SCN1-SCNn. In addition, a voltage Vera (V) is applied to the sustain electrodes SUS1-SUSn. The voltage Vera (V) has such a value that each discharge cell normally reset in the first step of the reset period would not reach the firing voltage. Thereafter, the voltage Vh (V) is applied to the sustain electrodes SUS1-SUSn at the start of the second step of the reset period. Throughout the excessive wall voltage erase step, no discharge is caused in each discharge cell in which a normal reset discharge has occurred. Thus, a wall voltage accumulated in such a discharge cell undergoes no change and the state observed at the time of the first step of the reset period is maintained.

In contrast, in each discharge cell in which an excessive wall voltage is accumulated on the scan electrode SCNi, the sustain electrode SUSi, and the address electrode Dj, application of the voltage Vera to the scan electrodes SCN1-SCNn causes the voltage to exceed the firing voltage (Vf), so that a strong discharge occurs. As a result, the wall voltage accumulated on the scan electrode SCNi, the sustain electrode SUSi, and the address electrode Dj is reversed to erase the wall voltage in the discharge cell.

The voltage Vera (V) varies depending on the partial pressure of Xe. Thus, the value of the voltage Vera (V) needs to be determined relatively to the partial pressure of Xe so as to cause a discharge only in the discharge cells in which an excessive wall voltage is accumulated in the first step of the reset period. In addition, the duration of an excessive wall voltage erase step needs to be long enough (for example, 0.5 μs to 50 μs or so) to reliably cause an erase discharge, even if a discharge is delayed for some other reasons.

As described above, the embodiment 2 achieves an effect similar to the embodiment 1. That is, if a strong discharge rather than a weak discharge occurs in the first step of a reset period, such a discharge cell is failed to be normally reset and an excessive wall voltage is accumulated. Through the excessive wall voltage erase step, however, the excessive wall voltage accumulated in each of such discharge cells is erased. This prevents occurrence of an erroneous discharge in the subsequent sustain period.

In addition, the embodiment 2 ensures that an excessive wall voltage is reliably erased before the second step of the reset period ends. For this reason, no influence is imposed on the wall voltage accumulated in the normally reset discharge cells. Thus, unlike the technique disclosed in the patent document 2, reduction of the address margin is avoided. Furthermore, since the excessively accumulated wall voltage is erased immediately after the first step of the reset period, each discharge cell is normally reset in the second step of the reset period. Thus, an address discharge in the subsequent address period is caused normally. With these advantage, the embodiment 2 realizes display images of good quality, without sacrificing the gray-scale quality, as in the technique disclosed in the patent document 2.

In addition, an erase discharge in the excessive wall voltage erase step is caused immediately after the first step of the reset period. Thus, a discharge delay is relatively small because of a sufficient amount of priming resulting from a strong discharge accidentally occurred in the first step and a weak discharge occurred in adjacent discharge cells. Taking advantage of this small discharge delay, a period necessary for reliably causing an erase discharge is shortened. With these advantages, the embodiment 2 is free from the problem associated with the technique disclosed in the patent document 2 and ensures a design margin of the erase period relatively easily.

Note that the embodiment 2 is described with reference to FIG. 8A. Yet, it is naturally appreciated that a similar effect is achieved by maintaining the same level of voltage Vr (V) even in the excessive wall voltage erase step, as illustrated in FIG. 8B.

In addition, the voltage Vera (V) shown in both FIGS. 8A and 8B is a positive voltage. Yet, it is naturally appreciated that an excessive wall voltage is erased by applying a negative voltage.

### Embodiment 3

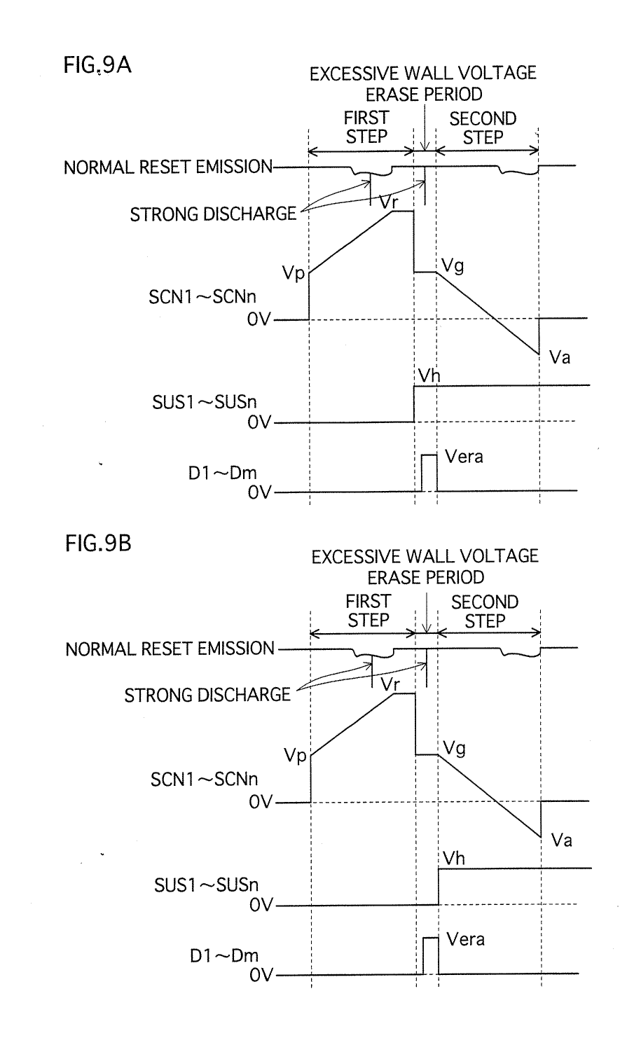

FIG. 9 illustrates drive waveforms applied in the all-cell reset period for driving a PDP according to an embodiment 3 of the present invention.

The embodiment 3 is based on the drive waveforms illustrated in FIG. 4 applied to the respective electrodes of a typical PDP. One feature of the embodiment 3 lies in that an excessive wall voltage erase step is provided between the first and second steps of an all-cell reset period as illustrated in FIG. 8. In the excessive wall voltage erase step, a potential change waveform that rises or falls is applied to the address electrodes D1-Dm.

Regarding the first and second steps of a reset period, the embodiment 3 employs the same sub-field pattern as the embodiment 1. Thus, a description thereof is omitted. The description below relates to an excessive wall voltage erase step that is different from the embodiment 1.

As illustrated in FIG. 9A, after the first step of the reset period ends, the voltage Vg (V) is applied to the scan electrodes SCN1-SCNn and the voltage Vh (V) is applied to the sustain electrodes SUS1-SUSn. Then, the voltage Vera (V) is applied to the address electrodes D1-Dm for a duration of 0.5 μs to 20 μs. The voltage Vh (V) has such a value that each discharge cell normally reset in the first step of the reset period would not reach the firing voltage. After application of the voltage Vera for the duration, the address electrodes D1-Dm is set to 0 (V). During the excessive wall voltage erase step according to the embodiment 3, no discharge is caused in each discharge cell in which a normal reset discharge has occurred, so that the wall voltage in such a discharge cell is maintained in the state observed at the time of the first step of the reset period. In contrast, in each discharge cell in which an excessive wall voltage is accumulated on the scan electrode SCNi, the sustain electrode SUSi, and the address electrode Dj, application of the voltage Vera to the scan electrodes SCN1-SCNn causes the voltage in the respective discharge cell to exceed the firing voltage (Vf), so that a strong discharge occurs. As a result, the wall voltage accumulated on the scan electrode SCNi, the sustain electrode SUSi, and the address electrode Dj is reversed to erase the wall voltage in the respective discharge cell. The value of voltage Vera (V) varies depending on the partial pressure of Xe. Thus, the voltage Vera (V) needs to be determined relatively to the partial pressure of Xe so as to cause a discharge only in the discharge cells in which an excessive wall voltage is accumulated in the first step of the reset period. In addition, the excessive wall voltage erase step needs to be long enough (for example, 0.5 μs to 50 μs or so) to reliably cause an erase discharge even if a discharge delay occurs for some other reasons.

With the driving method described above, an effect similar to the embodiments 1 and 2 is achieved.

Note that the embodiment 3 is described with reference to FIG. 9A. Yet, it is naturally appreciated that a similar effect is achieved by maintaining the sustain electrodes SUS1-SUSn at 0 (V) during the excessive wall voltage erase step, as illustrated in FIG. 9B.

In addition, the voltage Vera (V) shown in both FIGS. 9A and 9B is a positive voltage. Yet, it is naturally appreciated that an excessive wall voltage is erased by applying a negative voltage.

### Embodiment 4

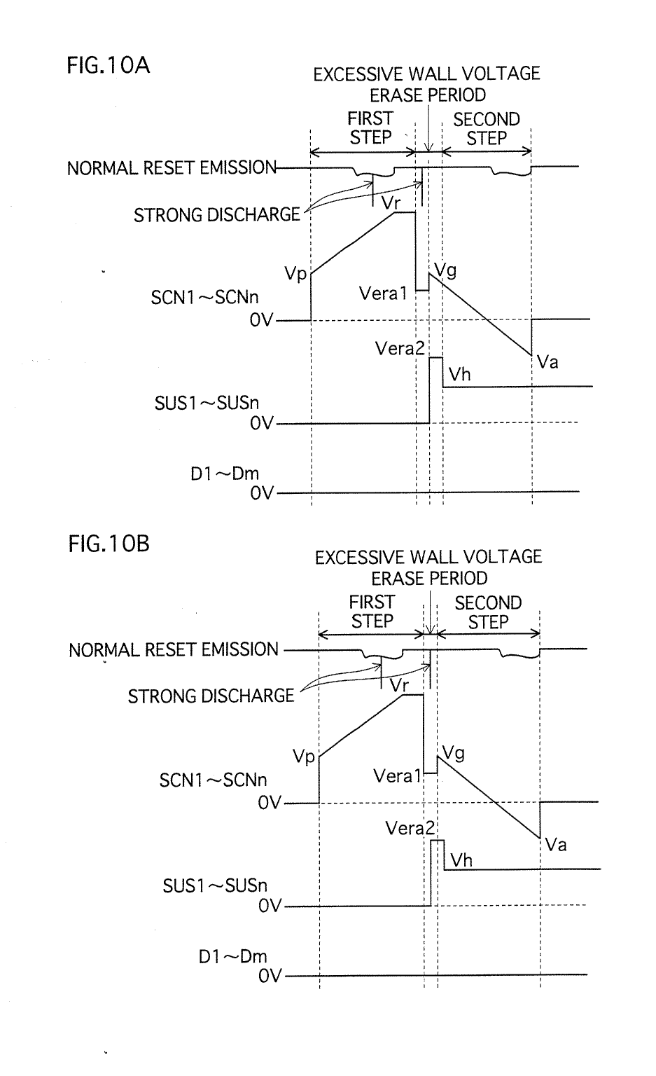

FIG. 10 illustrate drive waveforms applied in the all-cell reset period for driving a PDP according to an embodiment 4 of the present invention.

The embodiment 4 is based on the drive waveforms illustrated in FIG. 4 applied to the respective electrodes of a typical PDP. One feature of the embodiment 4 lies in that an excessive wall voltage erase step is provided between the first and second steps of an all-cell reset period as illustrated in FIG. 10. In the excessive wall voltage erase step, a potential change waveform that rises or falls is applied to the scan electrodes SCN1-SCNn and the sustain electrodes SUS1-SUSn.

Regarding the first and second steps of a reset period, the embodiment 4 employs the same sub-field pattern as the embodiment 1. Thus, a description thereof is omitted. The description below relates to an excessive wall voltage erase step that is different from the embodiment 1.

As illustrated in FIG. 10A, after the first step of the reset period ends, a voltage Vera1 (V) is applied to the scan electrodes SCN1-SCNn. The voltage Vera1 (V) has such a value that each discharge cell normally reset in the first step of the reset period would not reach the firing voltage. After the application of the voltage Vera1 (V), the voltage Vg (V) is applied to the scan electrodes SCN1-SCNn. At the same time, a voltage Vera2 (V) is applied to the sustain electrodes SUS1-SUSn. The voltage Vera2 (V) has such a value that each discharge cell normally reset in the first step of the reset period would not reach the firing voltage. During the excessive wall voltage erase step according to the embodiment 4, no discharge is caused in each discharge cell in which a normal reset discharge has occurred, so that the wall voltage in such a discharge cell is maintained in the state observed at the time of the first step of the reset period. In contrast, in each discharge cell in which an excessive wall voltage is accumulated on the scan electrode SCNi, the sustain electrode SUSi, and the address electrode Dj, application of the voltage Vera to the scan electrodes SCN1-SCNn causes the voltage in the respective discharge cell to exceed the firing voltage (Vf), so that a strong discharge occurs. As a result, the wall voltage accumulated on the scan electrode SCNi, the sustain electrode SUSi, and the address electrode Dj is reversed to erase the wall voltage in the respective discharge cell. The value of the voltage Vera (V) varies depending on the partial pressure of Xe. Thus, the voltage Vera (V) needs to be determined relatively to the partial pressure of Xe so as to cause a discharge only in the discharge cells in which an excessive wall voltage is accumulated in the first step of the reset period. In addition, the excessive wall voltage erase step needs to be long enough (for example, 0.5 μs to 50 μs or so) to reliably cause an erase discharge even if a discharge delay occurs for some other reasons. With the driving method described above, an effect similar to the embodiments 1-3 is achieved.

Note that the embodiment 4 is described with reference to FIG. 10A. Yet, an excessive wall voltage is erased even more reliably by applying the voltage Vera2 (V) to the sustain electrodes SUS1-SUSn during the application of voltage Vera1 (V) to the scan electrodes SCN1-SCNn, as illustrated in FIG. 10B.

In addition, the voltage Vera2 (V) shown in both FIGS. 10A and 10B is a positive voltage. Yet, it is naturally a appreciated that an excessive wall voltage is erased by applying a negative voltage.

### Embodiment 5

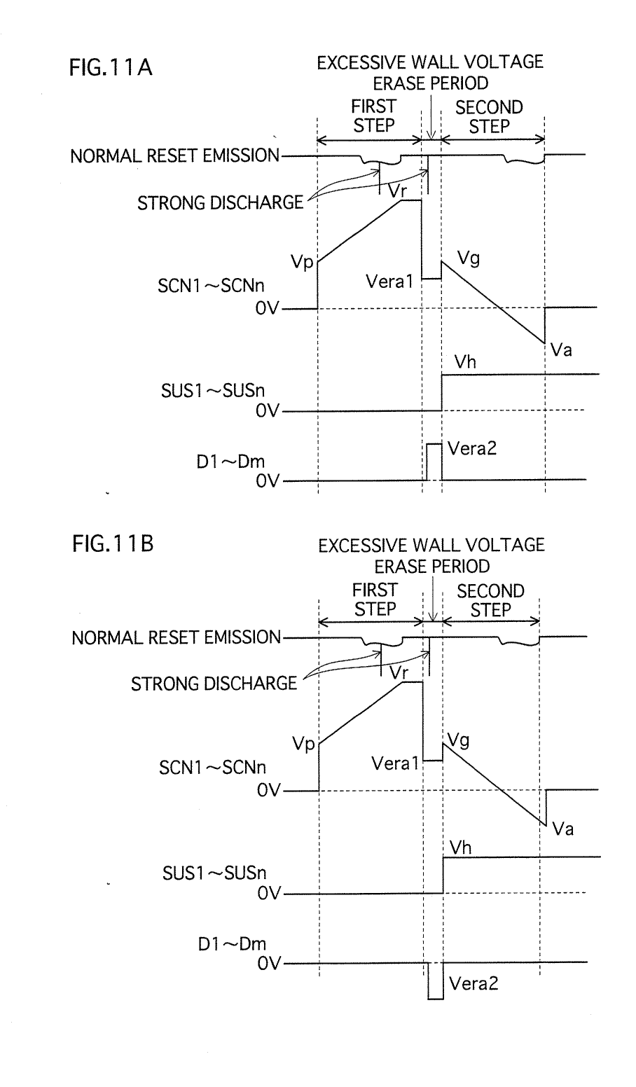

FIG. 11 illustrates drive waveforms applied in the all-cell reset period for driving a PDP according to an embodiment 5 of the present invention.

The embodiment 5 is based on the drive waveforms illustrated in FIG. 4 applied to the respective electrodes of a typical PDP. One feature of the embodiment 4 lies in that an excessive wall voltage erase step is provided between the first and second steps of an all-cell reset period as illustrated in FIG. 11. In the excessive wall voltage erase step, a potential change waveform that rises or falls is applied to the scan electrodes SCN1-SCNn and the address electrodes D1-Dm.

Regarding the first and second steps of a reset period, the embodiment 5 employs the same sub-field pattern as the embodiment 1. Thus, a description thereof is omitted. The description below relates to an excessive wall voltage erase step that is different from the embodiment 1.

As illustrated in FIG. 11A, after the first step of the reset period ends, a voltage Vera1 (V) is applied to the scan electrodes SCN1-SCNn and a voltage Vera2 is applied to the address electrodes D1-Dm for a duration of 0.5 μs to 20 μs. The voltage Vera1 and Vera2 both have such a value that each discharge cell normally reset in the first step of the reset period would not reach the firing voltage. During the excessive wall voltage erase step according to the embodiment 5, no discharge is caused in each discharge cell in which a normal reset discharge has occurred, so that the wall voltage in such a discharge cell is maintained in the state observed at the time of the first step of the reset period.

In contrast, in each discharge cell in which an excessive wall voltage is accumulated on the scan electrode SCNi, the sustain electrode SUSi, and the address electrode Dj, application of the voltage Vera to the scan electrodes SCN1-SCNn causes the voltage in the respective discharge cell to exceed the firing voltage (Vf), so that a strong discharge occurs. As a result, the wall voltage accumulated on the scan electrode SCNi, the sustain electrode SUSi, and the address electrode Dj is reversed to erase the wall voltage in the respective discharge cell. The value of the voltage Vera (V) varies depending on the partial pressure of Xe. Thus, the voltage Vera (V) needs to be determined relatively to the partial pressure of Xe so as to cause a discharge only in the discharge cells in which an excessive wall voltage is accumulated in the first step of the reset period. In addition, the excessive wall voltage erase step needs to be long enough (for example, 0.5 μs to 50 μs or so) to reliably cause an erase discharge even if a discharge delay occurs for some other reasons.

With the driving method described above, an effect similar to the embodiments 1-4 is achieved.

Note that the embodiment 5 is described with reference to FIG. 11A. Yet, it is naturally appreciated that a similar effect is achieved by applying, as the voltage Vera2, a negative voltage to the address electrodes D1-Dm, as illustrated in FIG. 11B.

In addition, according to both FIGS. 11A and 11B, the voltage Vh (V) is applied to the sustain electrodes SUS1-SUSn after the excessive wall voltage erase step ends. Yet, an excessive wall voltage is erased by applying the voltage Vh (V) during the excessive wall voltage erase step.

### Embodiment 6

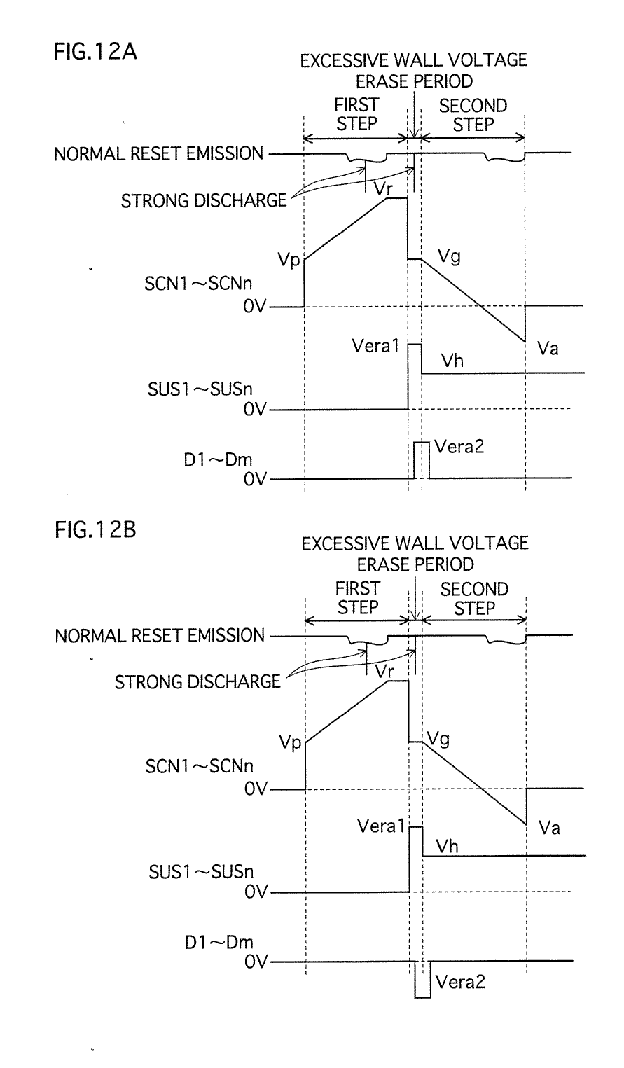

FIG. 12 illustrate drive waveforms applied in the all-cell reset period when driving a PDP according to an embodiment 6 of the present invention.

The embodiment 6 is based on the drive waveforms illustrated in FIG. 4 applied to the respective electrodes of a typical PDP. One feature of the embodiment 6 lies in that an excessive wall voltage erase step is provided between the first and second steps of an all-cell reset period as illustrated in FIG. 12. In the excessive wall voltage erase step, a potential change waveform that rises or falls is applied to the sustain electrodes SUS1-SUSn and the address electrodes D1-Dm.

Regarding the first and second steps of a reset period, the embodiment 6 employs the same sub-field pattern as the embodiment 1. Thus, a description thereof is omitted. The description below relates to an excessive wall voltage erase step that is different from the embodiment 1.

As illustrated in FIG. 12A, the voltage Vera1 (V) is applied to the sustain electrodes SUS1-SUSn and the voltage Vera2 (V) is applied to the address electrodes D1-Dm. The voltage Vera1 and Vera2 both has such a value that each discharge cell normally reset in the first step of the reset period would not reach the firing voltage. During the excessive wall voltage erase step according to the embodiment 6, no discharge is caused in each discharge cell in which a normal reset discharge has occurred. Thus, the wall voltage in such a discharge cell is maintained in the state observed at the time of the first step of the reset period. In contrast, in each discharge cell in which an excessive wall voltage is accumulated on the scan electrode SCNi, the sustain electrode SUSi, and the address electrode Dj, application of the voltage Vera to the scan electrodes SCN1-SCNn causes the voltage in the respective discharge cell to exceed the firing voltage (Vf), so that a strong discharge occurs. As a result, the wall voltage accumulated on the scan electrode SCNi, the sustain electrode SUSi, and the address electrode Dj is reversed to erase the wall voltage in the respective discharge cell. The value of the voltage Vera (V) varies depending on the partial pressure of Xe. Thus, the voltage Vera (V) needs to be determined relatively to the partial pressure of Xe so as to cause a discharge only in the discharge cells in which an excessive wall voltage is accumulated in the first step of the reset period. In addition, the excessive wall voltage erase step needs to be long enough (for example, 0.5 μs to 50 μs or so) to reliably cause an erase discharge even if a discharge delay occurs for some other reasons.

With the driving method described above, an effect similar to the embodiments 1-5 is achieved.

Note that the embodiment 6 is described with reference to FIG. 12A. Yet, it is naturally appreciated that a similar effect is achieved by applying, as the voltage Vera2, a negative voltage to the address electrodes D1-Dm, as illustrated in FIG. 12B.

In addition, according to both FIGS. 12A and 12B, the voltage Vera2 (V) is applied after application of the voltage Vera1 (V). Yet, an excessive wall voltage is erased by applying the voltage Vera2 (V) prior to application of the voltage Vera1 (V).

### <Additional Matters>

According to the embodiments 1-6 above, each potential change waveform applied in the respective excessive wall voltage erase step is a pulsed voltage having a rise or a fall. Yet, the potential change waveform may be a ramp voltage or a voltage that varies with a time constant.

According to the embodiments 1-6 above, the number of all-cell reset periods is varied in accordance with the APL. Yet, the present invention is not limited to such a driving method according to which every all-cell reset period includes an excessive wall voltage erase step. For example, an excessive wall voltage erase step may or may not be provided selectively in each discharge cell and the selection may be made relatively to the luminance weighing factor of the discharge cell.

It is applicable to additionally provide a panel temperature monitoring unit for monitoring the temperature of the panel. The number of reset periods or of the excessive wall voltage erase steps to be provided may be adjusted relatively to the temperature information.

In addition, the temperature information may be used to determine the duration of an excessive wall voltage erase step and the value of voltage Vera (V).

It is also applicable to additionally provide a total time measuring unit for measuring a time period for which the PDP apparatus is used. The number of reset periods or of the excessive wall voltage erase steps to be provided may be adjusted relatively to the total time information.

In addition, the total time information may be used to determine the duration of the excessive wall voltage erase step and the value of the voltage Vera (V).

Each of the embodiments 1-6 above relates to a PDP of a three-electrode surface discharge structure. Yet, the present invention is applicable to a PDP having a different electrode structure. For example, the present invention is applicable to a PDP having auxiliary electrodes extending in parallel to the scan, sustain, or address electrodes. The auxiliary electrodes is used specifically for applying a potential change waveform in the excessive wall voltage erase step.

The “PDPs having a resolution comparable to HD (High Definition) or higher” used in this specification refers to PDPs including the following.

a. For 37-inch panels: panels having a resolution higher than HD panels with 1024×720 (pixels);

b. For 42-inch panels: panels having a resolution higher than HD panels with 1024×768 (pixels); and

c. For 50-inch panels: panels having a resolution higher than HD panels with 1366×768 (pixels)

In addition, the PDPs having a resolution that is equal to or higher than HD also include full HD panels (1920×80 (pixels))

### INDUSTRIAL APPLICABILITY

The present invention is applicable to plasma display panels used as television sets in households or as large display devices at public facilities.

1. A method for driving a plasma display apparatus through a driving process according to which each of a plurality of fields includes a plurality of sub-fields, the plasma display apparatus having:
a plurality of display electrode pairs each composed of a scan electrode and a sustain electrode;
a plurality of address electrodes that are separated from the display electrode pairs by a discharge space and that extend in a direction intersecting the display electrode pairs; and
a plurality of discharge cells formed at locations corresponding to the intersections, the method being characterized in that
at least one sub-field in each field includes an all-cell reset period in which an erase discharge is caused in all the discharge cells,
the all-cell reset period includes:
a first step of applying an ascending ramp waveform voltage to the scan electrodes, so that a first reset discharge is caused between each of the scan electrodes and a corresponding one of the data and/or sustain electrodes;
a second step of applying a descending ramp waveform voltage to the scan electrodes, so that a second reset discharge is caused between each of the scan electrodes and a corresponding one of the data and/or sustain electrodes; and
an excessive wall voltage erase step of applying, between the first and second steps, a potential-change waveform to at least either the scan electrodes, the sustain electrodes, or the address electrodes, so that an excessive wall voltage in each discharge cell is erased, the potential-change waveform having a ramp that is steeper than the descending ramp of the waveform voltage applied in the second step to the scan electrodes.

2. The method of claim 1, wherein
the potential-change waveform is a pulsed waveform.

3. The method of claim 1, wherein
the potential-change waveform is applied to the scan electrodes.

4. The method of claim 3, wherein
after the potential-change waveform application to the scan electrodes, the potential-change waveform is applied to the sustain electrodes.

5. The method of claim 3, wherein
during the potential-change waveform application to the scan electrodes, the potential-change waveform is applied to the sustain electrodes.

6. The method of claim 1, wherein
the potential-change waveform is applied to the sustain electrodes.

7. The method of claim 6, wherein
the potential-change waveform is applied to the sustain electrodes after the first step ends and before a potential of the scan electrodes changes.

8. The method of claim 6, wherein
the potential-change waveform is applied to the sustain electrodes after the first step ends and after a potential of the scan electrodes changes.

9. The method of claim 1, wherein
the potential-change waveform is applied to the address electrodes.

10. The method of claim 9, wherein
during the potential-change waveform application, the address electrodes act as positively charged electrodes.

11. The method of claim 10, wherein
the potential-change waveform is applied to the address electrodes after a potential of the sustain electrodes changes.

12. The method of claim 10, wherein
the potential-change waveform is applied the address electrodes before a potential of the sustain electrodes changes.

13. The method of claim 1, wherein
the potential-change waveform is applied to the scan and sustain electrodes.

14. The method of claim 13, wherein
the potential-change waveform is applied to the sustain electrodes after the potential-change waveform is applied to the scan electrodes.

15. The method of claim 13, wherein
the potential-change waveform is applied to the sustain electrodes during the potential-change waveform application to the scan electrodes.

16. The method of claim 1, wherein
the potential-change waveform is applied to the scan and address electrodes.

17. The method of claim 16, wherein
the potential-change waveform is applied to the address electrodes during the potential-change waveform application to the scan electrode and before the potential-change waveform application to the sustain electrodes.

18. The method of claim 17, wherein
the potential-change waveform is applied to the address electrodes, so that the address electrodes act as positively charged electrodes.

19. The method of claim 17, wherein
the potential-change waveform is applied to the address electrodes, so that the address electrodes act as negatively charged electrodes.

20. The method of claim 16, wherein
the potential-change waveform is applied to the address electrodes during the potential-change waveform application to the scan electrodes and after the potential-change waveform application to the sustain electrodes.

21. The method of claim 20, wherein
the potential-change waveform is applied to the address electrodes, so that the address electrodes act as positively charged electrodes.

22. The method of claim 20, wherein
the potential-change waveform is applied to the address electrodes, so that the address electrodes act as negatively charged electrodes.

23. The method of claim 1, wherein
the potential-change waveform is applied to the sustain and address electrodes.

24. The method of claim 23, wherein
the potential-change waveform is applied to the address electrodes during the potential-change waveform application to the sustain electrodes.

25. The method of claim 24, wherein
the potential-change waveform is applied to the address electrodes, so that the address electrodes act as cathodes relative to the scan and sustain electrodes.

26. The method of claim 24, wherein
the potential-change waveform is applied to the address electrodes, so that the address electrodes act as anodes relative to the scan and sustain electrodes.

27. The method of claim 23, wherein
the potential-change waveform is applied to the sustain electrodes during the potential-change waveform application to the address electrodes.

28. The method of claim 27, wherein
the potential-change waveform is applied to the sustain electrodes, so that the sustain electrodes act as anodes relative to the scan and address electrodes.

29. The method of claim 27, wherein
the potential-change waveform is applied to the sustain electrodes, so that the sustain electrodes act as cathodes relative to the scan and address electrodes.

30. The method of claim 1, wherein
when an APL of an image to be displayed is lower than a predetermined value, a decreased number of subfields include a step in which the all-cell reset is performed, and
when the APL of the image to be displayed is higher than a predetermined value, an increased number of subfields include a step in which the all-cell reset is performed.

31. The method of claim 1, wherein
a resolution of the plasma display panel is equal to or higher than a resolution of high-vision.

32. The method of claim 1, wherein
the discharge space of the plasma display panel includes Xe, and
a partial pressure of Xe in a discharge gas filled in the discharge space is 7% or higher.

33. The method of claim 1, wherein
the potential-change waveform is adjusted in one or both of amplitude and width according to an APL.

34. The method of claim 1, wherein
the potential-change waveform is adjusted in one or both of amplitude and width according to one or both of a drive time period and a panel temperature.

35. A plasma display panel apparatus comprising:
a plasma display panel unit; and
a drive unit connected to the plasma display panel unit, the plasma display panel apparatus being characterized in that
the drive unit is operable to drive the plasma display panel unit according to a driving method defined in claim 1.
